(19) United States
(12) Patent Application Publication
(10) Pub. No.: US 2021/0335318 A1
(43) Pub. Date: Oct. 28, 2021

(54) DRIVING METHOD, DISPLAY PANEL AND DISPLAY DEVICE

(71) Applicant: TCL China Star Optoelectronics Technology Co., Ltd., Shenzhen (CN)

(72) Inventor: Yongquan CHEN, Shenzhen (CN)

(21) Appl. No.: 16/622,916

(22) PCT Filed: Nov. 22, 2019
(86) PCT No.: PCT/CN2019/120091

§ 371 Date: Dec. 16, 2019

(30) Foreign Application Priority Data
Nov. 15, 2019 (CN) 201911122225.3

(51) Int. Cl. G09G 3/36

(52) U.S. Cl. CPC G09G 3/3696; G09G 2320/0247; G09G 2320/0693

(57) ABSTRACT

Embodiments of the present application disclose a driving method, a display panel and a display device. The driving method includes obtaining a common electrode feedback voltage of the reference region and the common electrode feedback voltage of the to-be-calibrated regions; compensating a source voltage of the to-be-calibrated regions based on the common electrode feedback voltage of the reference region and the common electrode feedback voltage of the to-be-calibrated regions to obtain a compensated source voltage; and outputting the compensated source voltage to a corresponding source electrode of the to-be-calibrated regions.

This application claims the benefit of priority of a China Patent Application No. 201911122225.3 submitted to State Intellectual Property Office of the P.R.C. on Nov. 15, 2019, entitled “DRIVING METHOD, DISPLAY PANEL AND DISPLAY DEVICE”, the contents of which are incorporated herein by reference in their entirety.

### FIELD OF THE DISCLOSURE

The present application relates to display technologies, and more particularly to a driving method, a display panel and a display device.

### DESCRIPTION OF RELATED ARTS

With the development of display technologies, liquid crystal display devices have been favored by a large number of users due to small size and low power consumption. The liquid crystal display device generally includes a backlight module and a liquid crystal display panel. The backlight module is used to provide light rays for the liquid crystal display panel. The liquid crystal display panel is used to display information such as text and images. When the liquid crystal display panel displays information such as text and images, the display effect will be affected if a flicker occurs.

Driving a pixel dot on a liquid crystal display device is achieved by a voltage difference between a source voltage and a common electrode voltage that are applied at two ends of the pixel point, respectively. The source voltage is outputted individually for each column by a dedicated driving circuit. The common electrode voltage is provided by a voltage of a common electrode on a plane. The source voltage is alternately changed with positive and negative polarities in order to prevent liquid crystal molecules of the pixel from being polarized. In the ideal situation, the voltage differences formed between the common electrode voltage and the positive and negative source voltages should also be symmetrical.

At present, the common electrode on the display panel of the liquid crystal display device is mostly a piece of transparent metal. Because the entire metal area is large, film thickness of each region of the common electrode cannot be completely consistent during production process. Therefore, resistance of the regions of the common electrode may differ, thereby affecting the display effect.

That is, in the existing arts, an offset of the common electrode feedback voltage of each region in the display panel with respect to the source voltage will affect display effect.

### Technical Problems

That is, in the existing arts, an offset of the common electrode feedback voltage of each region in the display panel with respect to the source voltage will affect display effect.

### Technical Solutions

Embodiments of the present application provide a driving method, a display panel and a display device, capable of adjusting an offset of a common electrode feedback voltage with respect to a source voltage, thereby ensuring display effects.

To solve above problems, in a first aspect, the present application provides a driving method, applied to a display panel, which includes a plurality of display regions arranged along a horizontal direction, in which one of the display regions is a reference region and the others of the display regions are to-be-calibrated regions, the display panel including source electrodes and a common electrode, the driving method including:

obtaining a common electrode feedback voltage of the reference region and the common electrode feedback voltage of the to-be-calibrated regions;

compensating a source voltage of the to-be-calibrated regions based on the common electrode feedback voltage of the reference region and the common electrode feedback voltage of the to-be-calibrated regions to obtain a compensated source voltage; and

outputting the compensated source voltage to a corresponding source electrode of the to-be-calibrated regions.

Amongst, compensating the source voltage of the to-be-calibrated regions based on the common electrode feedback voltage of the reference region and the common electrode feedback voltage of the to-be-calibrated regions to obtain the compensated source voltage includes:

comparing the common electrode feedback voltage of the reference region with the common electrode feedback voltage of the to-be-calibrated regions to obtain a difference between the common electrode feedback voltages of the reference region and the to-be-calibrated regions; and

compensating a corresponding source voltage of the to-be-calibrated regions based on the difference between the common electrode feedback voltages of the reference region and the to-be-calibrated regions to obtain the compensated source voltage.

Amongst, the display panel includes a first display region and a second display region, and the first display region is the reference region and the second display region is the to-be-calibrated region,

wherein obtaining the common electrode feedback voltage of the reference region and the common electrode feedback voltage of the to-be-calibrated regions includes:

obtaining the common electrode feedback voltage of the first display region and the common electrode feedback voltage of the second display region,

wherein compensating the source voltage of the to-be-calibrated regions based on the common electrode feedback voltage of the reference region and the common electrode feedback voltage of the to-be-calibrated regions to obtain the compensated source voltage includes:

compensating the source voltage of the second display region based on the common electrode feedback voltage of the first display region and the common electrode feedback voltage of the second display region to obtain the compensated source voltage of the second display region.

Amongst, the display panel further includes a third display region, the second display region and the third display region are the to-be-calibrated regions, and the reference region is located at a middle part of the display panel and the reference region is located between the second display region and the third display region,

wherein obtaining the common electrode feedback voltage of the reference region and the common electrode feedback voltage of the to-be-calibrated regions includes:

obtaining the common electrode feedback voltage of the third display region;

wherein compensating the source voltage of the to-be-calibrated regions based on the common electrode feedback voltage of the reference region and the common electrode feedback voltage of the to-be-calibrated regions to obtain the compensated source voltage includes:

compensating the source voltage of the third display region based on the common electrode feedback voltage of the first display region and the common electrode feedback voltage of the third display region to obtain the compensated source voltage of the third display region.

Amongst, compensating the source voltage of the second display region based on the common electrode feedback voltage of the first display region and the common electrode feedback voltage of the second display region to obtain the compensated source voltage of the second display region.

obtaining the source voltage corresponding to the second display region; and

adding up the source voltage corresponding to the second display region and a difference between the common electrode feedback voltages of the first display region and the second display region to obtain the compensated source voltage of the second display region.

Amongst, obtaining the common electrode feedback voltage of the reference region and the common electrode feedback voltage of the to-be-calibrated regions includes:

correcting the common electrode feedback voltage of the reference region to be a predetermined voltage.

Amongst, the common electrode of the first display region is provided with a first voltage feedback pin, the common electrode of the to-be-calibrated regions is provided with at least one second voltage feedback pin, and obtaining the common electrode feedback voltage of the reference region and the common electrode feedback voltage of the to-be-calibrated regions includes:

obtaining the common electrode feedback voltage of the reference region by the first voltage feedback pin and obtaining the common electrode feedback voltage of the to-be-calibrated regions by the at least one second voltage feedback pin.

Amongst, the first voltage feedback pin and the at least one second voltage feedback pin are located at a same side of the common electrode, a common electrode input voltage is inputted to the common electrode at a side of the common electrode where the first voltage feedback pin and the second voltage feedback pin are disposed,

wherein correcting the common electrode feedback voltage of the reference region to be the predetermined voltage includes:

correcting the common electrode feedback voltage of the to-be-calibrated regions to the predetermined voltage by adjusting the common electrode input voltage.

To solve above problems, in a second aspect, the present application provides a display panel, including a comparing circuit and a calibrating circuit that are coupled to each other, the display panel including a plurality of display regions arranged along a horizontal direction, in which one of the display regions is a reference region and the others of the display regions are to-be-calibrated regions, the display panel including source electrodes and a common electrode;

the comparing circuit, connected to the common electrodes of the reference region and the to-be-calibrated regions, configured to obtain a common electrode feedback voltage of the reference region and the common electrode feedback voltage of the to-be-calibrated regions;

the calibrating circuit, configured to compensating a source voltage of the to-be-calibrated regions based on the common electrode feedback voltage of the reference region and the common electrode feedback voltage of the to-be-calibrated regions to obtain a compensated source voltage; and

the calibrating circuit, configured to output the compensated source voltage to a corresponding source electrode of the to-be-calibrated regions.

Amongst, compensating the source voltage of the to-be-calibrated regions based on the common electrode feedback voltage of the reference region and the common electrode feedback voltage of the to-be-calibrated regions to obtain the compensated source voltage includes:

comparing the common electrode feedback voltage of the reference region with the common electrode feedback voltage of the to-be-calibrated regions to obtain a difference between the common electrode feedback voltages of the reference region and the to-be-calibrated regions; and

compensating a corresponding source voltage of the to-be-calibrated regions based on the difference between the common electrode feedback voltages of the reference region and the to-be-calibrated regions to obtain the compensated source voltage.

Amongst, the display panel includes a first display region and a second display region, and the first display region is the reference region and the second display region is the to-be-calibrated region,

wherein obtaining the common electrode feedback voltage of the reference region and the common electrode feedback voltage of the to-be-calibrated regions includes:

obtaining the common electrode feedback voltage of the first display region and the common electrode feedback voltage of the second display region,

wherein compensating the source voltage of the to-be-calibrated regions based on the common electrode feedback voltage of the reference region and the common electrode feedback voltage of the to-be-calibrated regions to obtain the compensated source voltage includes:

compensating the source voltage of the second display region based on the common electrode feedback voltage of the first display region and the common electrode feedback voltage of the second display region to obtain the compensated source voltage of the second display region.

Amongst, the display panel further includes a third display region, the second display region and the third display region are the to-be-calibrated regions, and the reference region is located at a middle part of the display panel and the reference region is located between the second display region and the third display region,

wherein obtaining the common electrode feedback voltage of the reference region and the common electrode feedback voltage of the to-be-calibrated regions includes:

obtaining the common electrode feedback voltage of the third display region;

wherein compensating the source voltage of the to-be-calibrated regions based on the common electrode feedback voltage of the reference region and the common electrode feedback voltage of the to-be-calibrated regions to obtain the compensated source voltage includes:

compensating the source voltage of the third display region based on the common electrode feedback voltage of the first display region and the common electrode feedback voltage of the third display region to obtain the compensated source voltage of the third display region.

Amongst, compensating the source voltage of the second display region based on the common electrode feedback voltage of the first display region and the common electrode feedback voltage of the second display region to obtain the compensated source voltage of the second display region.

obtaining the source voltage corresponding to the second display region; and

adding up the source voltage corresponding to the second display region and a difference between the common electrode feedback voltages of the first display region and the second display region to obtain the compensated source voltage of the second display region.

Amongst, obtaining the common electrode feedback voltage of the reference region and the common electrode feedback voltage of the to-be-calibrated regions includes:

correcting the common electrode feedback voltage of the reference region to be a predetermined voltage.

Amongst, the common electrode of the first display region is provided with a first voltage feedback pin, the common electrode of the to-be-calibrated regions is provided with at least one second voltage feedback pin, and obtaining the common electrode feedback voltage of the reference region and the common electrode feedback voltage of the to-be-calibrated regions includes:

obtaining the common electrode feedback voltage of the reference region by the first voltage feedback pin and obtaining the common electrode feedback voltage of the to-be-calibrated regions by the at least one second voltage feedback pin.

Amongst, the first voltage feedback pin and the at least one second voltage feedback pin are located at a same side of the common electrode, a common electrode input voltage is inputted to the common electrode at a side of the common electrode where the first voltage feedback pin and the second voltage feedback pin are disposed,

wherein correcting the common electrode feedback voltage of the reference region to be the predetermined voltage includes:

correcting the common electrode feedback voltage of the to-be-calibrated regions to the predetermined voltage by adjusting the common electrode input voltage.

To solve above problems, in a third aspect, the present application provides a display device, including a display panel including a comparing circuit and a calibrating circuit that are coupled to each other, the display panel including a plurality of display regions arranged along a horizontal direction, in which one of the display regions is a reference region and the others of the display regions are to-be-calibrated regions, the display panel including source electrodes and a common electrode;

the comparing circuit, connected to the common electrodes of the reference region and the to-be-calibrated regions, configured to obtain a common electrode feedback voltage of the reference region and the common electrode feedback voltage of the to-be-calibrated regions;

the calibrating circuit, configured to compensating a source voltage of the to-be-calibrated regions based on the common electrode feedback voltage of the reference region and the common electrode feedback voltage of the to-be-calibrated regions to obtain a compensated source voltage; and

the calibrating circuit, configured to output the compensated source voltage to a corresponding source electrode of the to-be-calibrated regions.

Amongst, compensating the source voltage of the to-be-calibrated regions based on the common electrode feedback voltage of the reference region and the common electrode feedback voltage of the to-be-calibrated regions to obtain the compensated source voltage includes:

comparing the common electrode feedback voltage of the reference region with the common electrode feedback voltage of the to-be-calibrated regions to obtain a difference between the common electrode feedback voltages of the reference region and the to-be-calibrated regions; and

compensating a corresponding source voltage of the to-be-calibrated regions based on the difference between the common electrode feedback voltages of the reference region and the to-be-calibrated regions to obtain the compensated source voltage.

Amongst, the display panel includes a first display region and a second display region, and the first display region is the reference region and the second display region is the to-be-calibrated region,

wherein obtaining the common electrode feedback voltage of the reference region and the common electrode feedback voltage of the to-be-calibrated regions includes:

obtaining the common electrode feedback voltage of the first display region and the common electrode feedback voltage of the second display region,

wherein compensating the source voltage of the to-be-calibrated regions based on the common electrode feedback voltage of the reference region and the common electrode feedback voltage of the to-be-calibrated regions to obtain the compensated source voltage includes:

compensating the source voltage of the second display region based on the common electrode feedback voltage of the first display region and the common electrode feedback voltage of the second display region to obtain the compensated source voltage of the second display region.

Amongst, the display panel further includes a third display region, the second display region and the third display region are the to-be-calibrated regions, and the reference region is located at a middle part of the display panel and the reference region is located between the second display region and the third display region,

wherein obtaining the common electrode feedback voltage of the reference region and the common electrode feedback voltage of the to-be-calibrated regions includes:

obtaining the common electrode feedback voltage of the third display region;

wherein compensating the source voltage of the to-be-calibrated regions based on the common electrode feedback voltage of the reference region and the common electrode feedback voltage of the to-be-calibrated regions to obtain the compensated source voltage includes:

compensating the source voltage of the third display region based on the common electrode feedback voltage of the first display region and the common electrode feedback voltage of the third display region to obtain the compensated source voltage of the third display region.

### Beneficial Effects

Different from the existing arts, the present application provides a driving method, applied to a display panel, which includes a plurality of display regions arranged along a horizontal direction, in which one of the display regions is a reference region and the others of the display regions are to-be-calibrated regions, the display panel including source electrodes and a common electrode, the driving method including: obtaining a common electrode feedback voltage of the reference region and the common electrode feedback voltage of the to-be-calibrated regions; compensating a source voltage of the to-be-calibrated regions based on the common electrode feedback voltage of the reference region and the common electrode feedback voltage of the to-be-calibrated regions to obtain a compensated source voltage; and outputting the compensated source voltage to a corresponding source electrode of the to-be-calibrated regions. The present application compensates the source voltage corresponding to the to-be-calibrated regions based on the common electrode feedback voltage of the reference region and the common electrode feedback voltage of the to-be-calibrated regions and outputs it to a corresponding source electrode of the to-be-calibrated regions. That is, the source voltage of the to-be-calibrated regions is compensated by taking the reference region as a reference. By compensating the source voltage, an offset of the common electrode feedback voltage of each region with respect to the source voltage is adjusted, thereby ensuring the display effect.

### DESCRIPTION OF DRAWINGS

For explaining the technical solutions used in the embodiments of the present application more clearly, the appended figures to be used in describing the embodiments will be briefly introduced in the following. Obviously, the appended figures described below are only some of the embodiments of the present application, and those of ordinary skill in the art can further obtain other figures according to these figures without making any inventive effort.

FIG. 1 is a structural schematic diagram showing a display panel provided in an embodiment of the present application.

FIG. 2 is a structural schematic diagram showing source electrodes and a common electrode in a first display region of the display panel shown in FIG. 1.

FIG. 3 is a flowchart of a driving method provided in an embodiment of the present application.

FIG. 4 is a schematic diagram illustrating a source voltage and a common electrode feedback voltage at the time the common electrode feedback voltage of the first display region is corrected to a predetermined voltage in Step S31.

FIG. 5 is a schematic diagram illustrating a source voltage and a common electrode feedback voltage at the time a compensated source voltage is inputted to a source electrode of the second display region in Step S33.

FIG. 6 is a structural schematic diagram showing a display panel provided in another embodiment of the present application.

### DESCRIPTION OF EMBODIMENTS OF THE DISCLOSURE

The technical solutions in the embodiments of the present application are clearly and completely described below with reference to appending drawings of the embodiments of the present application. Obviously, the described embodiments are merely a part of embodiments of the present application and are not all of the embodiments. Based on the embodiments of the present application, all the other embodiments obtained by those of ordinary skill in the art without making any inventive effort are within the scope the present application.

In the description of the present application, it is to be understood that the terms “center”, “longitudinal”, “lateral”, “length”, “width”, “thickness”, “upper”, “lower”, “front”, “rear”, “left”, “right”, “vertical”, “horizontal”, “top”, “bottom”, “inner”, “outer”, and the like indicated orientation or positional relationship are based on the relationship of the position or orientation shown in the drawings, which is only for the purpose of facilitating description of the present application and simplifying the description, but is not intended to or implied that the device or element referred to must have a specific orientation, and be constructed and operated in a particular orientation. Therefore, it should not be construed as a limitation of the present disclosure. In addition, the terms “first” and “second” are used for descriptive purposes only, and should not be taken to indicate or imply relative importance, or implicitly indicate the indicated number of technical features. Thus, by defining a feature with “first” or “second” may explicitly or implicitly include one or more features. In the description of the present application, “a plurality” means two or more unless explicitly defined.

The word “exemplary” is used herein to mean “serving as an example, instance, or illustration.” Any embodiment described herein as “exemplary” is not necessarily to be construed as preferred or advantageous over other embodiments. The following description is provided in order to implement and utilize the present application by those of ordinary skill in the art. Details are also provided below for the purpose of explanation. It should be understood that those of ordinary skill in the art can be acknowledged that the present application is also achievable without these specific details. In other examples, well-known structures and processes will not be detailedly described in order not to render the description of the present application obscure by unnecessary details. Therefore, the present application is not intended to be limited to the illustrated embodiments, but is to be consistent with the widest range covered by the disclosed principles and features of the present application.

Embodiments of the present application provide a driving method, applied to a display panel, which includes a plurality of display regions arranged along a horizontal direction, in which one of the display regions is a reference region and the others of the display regions are to-be-calibrated regions, the display panel including source electrodes and a common electrode, the driving method including: obtaining a common electrode feedback voltage of the reference region and the common electrode feedback voltage of the to-be-calibrated regions; compensating a source voltage of the to-be-calibrated regions based on the common electrode feedback voltage of the reference region and the common electrode feedback voltage of the to-be-calibrated regions to obtain a compensated source voltage; and outputting the compensated source voltage to a corresponding source electrode of the to-be-calibrated regions.

Embodiments of the present application further provide a display panel, including a comparing circuit and a calibrating circuit that are coupled to each other, the display panel including a plurality of display regions arranged along a horizontal direction, in which one of the display regions is a reference region and the others of the display regions are to-be-calibrated regions, the display panel including source electrodes and a common electrode; the comparing circuit, connected to the common electrodes of the reference region and the to-be-calibrated regions, configured to obtain a common electrode feedback voltage of the reference region and the common electrode feedback voltage of the to-be-calibrated regions; the calibrating circuit, configured to compensating a source voltage of the to-be-calibrated regions based on the common electrode feedback voltage of the reference region and the common electrode feedback voltage of the to-be-calibrated regions to obtain a compensated source voltage; and the calibrating circuit, configured to output the compensated source voltage to a corresponding source electrode of the to-be-calibrated regions. The display device of the embodiments of the present application can be applied to a display device. Detailed description is provided below.

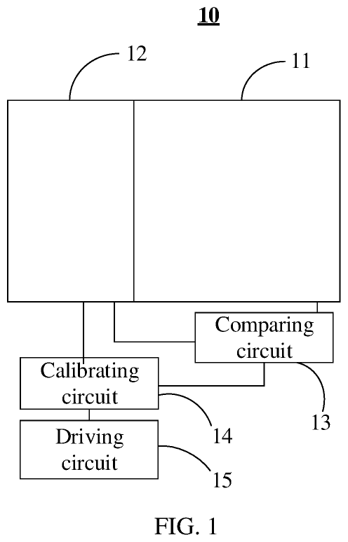

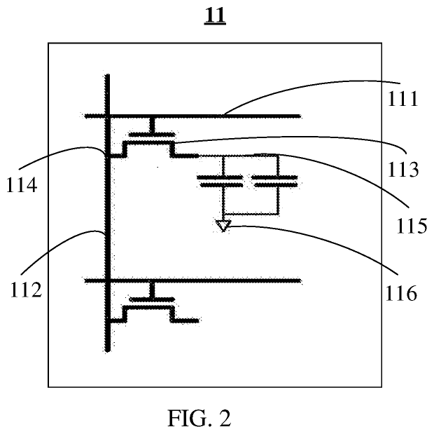

FIG. 1 is a structural schematic diagram showing a display panel provided in an embodiment of the present application. FIG. 2 is a structural schematic diagram showing source electrodes and a common electrode in a first display region of the display panel shown in FIG. 1.

In the present embodiment, the display panel 10 includes a comparing circuit 13 and a calibrating circuit 14 that are coupled to each other. The display panel 10 includes a plurality of display regions arranged along a horizontal direction. One of the display regions is a reference region and the others of the display regions are to-be-calibrated regions. The display panel 10 includes source electrodes 114 and a common electrode 116. The display panel 10 may include two, three or more display regions.

As shown in FIG. 1, the display panel 10 includes a first display region 11 and a second display region 12. The first display region 11 is the reference region and the second display region 12 is the to-be-calibrated region.

In a specific embodiment, the first display region 11 includes a plurality of gate lines 111 and a plurality of data lines 112 that are interlaced with each other. Thin-film transistors 113 are disposed at cross points of the gate lines 111 and the data lines 112. The gate line 111 and the data line 112 are connected to a gate electrode and a source electrode 114 of the thin-film transistor 113, respectively, thereby controlling the potential of a pixel electrode 115 to control a voltage difference between the pixel electrode 115 and the common electrode 116 such that the display panel 10 functions normally. The driving circuit 15 inputs a source voltage to the source electrode 114. The source voltage includes a first source voltage and a second source voltage. The first source voltage and the second source voltage are alternatively changed so as to avoid polarization of liquid crystal molecules. The common electrode 116 is a transparent metal plate occupying the first display region 11 and the second display region 12. The common electrode 116 and the source electrode 114 in the second display region 12 are similar to that in the first display region 11, and are not repeated herein.

In the present embodiment, the comparing circuit 13 is connected to the common electrode 116 of the first display region 11 and the common electrode 116 of the second display region 12 so as to obtain a common electrode feedback voltage of the first display region 11 and the common electrode feedback voltage of the second display region 12. The comparing circuit 13 is configured to compare the common electrode feedback voltage of the first display region 11 with the common electrode feedback voltage of the second display region 12 to obtain a difference between the common electrode feedback voltages of the first display region 11 and the second display region 12. The calibrating circuit is configured to compensate the source voltage corresponding to the second display region 12 based on the difference between the common electrode feedback voltages of the first display region 11 and the second display region 12 to obtain a compensated source voltage. The calibrating circuit 14 is configured to output the compensated source voltage to the source electrode 114 of the second display region 12.

Specifically, the calibrating circuit 14 is connected to a driving circuit 15 of the display panel 10 and is configured to obtain the source voltage corresponding to the second display region 12.

In other embodiments, the display region 10 may further includes a third display region, a fourth display region, or more display regions, and the present application is not limited thereto. Dividing the display region of the display panel 10 into a plurality of regions can further improve the calibration.

In a preferred embodiment, the first display region 11 is a middle part of the display region of the display panel 10, and the second display region 12 is a peripheral area of the display region of the display panel 10. Calibrating the display effect of the peripheral area on a basis of the middle part of the display region of the display panel 10 can improve the convenience of calibration, reduce the area needed to be calibrated, and increase the efficiency of calibration.

In a preferred embodiment, both of the comparing circuit 13 and the calibrating circuit 14 are located in a non-display region of the display panel 10. Specifically, the display panel 10 includes a display region and a non-display region. The non-display region is located at a peripheral area of the display region. The display region includes the first display region 11 and the second display region 12. Disposing the comparing circuit 13 and the calibrating circuit 14 in the non-display region can prevent the display effect of the display region of the display panel 10 from being affected by the circuits.

Further, the display panel 10 includes a correcting circuit (not shown). The correcting circuit is configured to correct the common electrode feedback voltage of the first display region 11 to a predetermined voltage. Specifically, it can be ensured that a flicker will not occur in the first display region 11 of the display panel 10 when a difference between the first source voltage and the predetermined voltage is equal to a difference between the predetermined voltage and the second source voltage in the first display region 11.

Further, the common electrode 116 of the first display region 11 is provided with a first voltage feedback pin and the common electrode 16 of the second display region 12 is provided with a second voltage feedback pin. The comparing circuit 13 obtains the common electrode feedback voltage of the first display region 11 by the first voltage feedback pin. The comparing circuit 13 obtains the common electrode feedback voltage of the second display region 12 by the second voltage feedback pin. Obviously, when there are a plurality of display regions treated as the to-be-calibrated regions, a plurality of second voltage feedback pins are correspondingly disposed for obtaining the common electrode feedback voltages of the plural display regions in the to-be-calibrated regions. That is, the to-be-calibrated regions are provided with at least one second voltage feedback pin for obtaining the common electrode feedback voltages of the to-be-calibrated regions.

Further, the first voltage feedback pin and the second voltage feedback pin are located at a same side of the common electrode 116. A common electrode input voltage is inputted to the common electrode 116 at a side of the common electrode 116 where the first voltage feedback pin and the second voltage feedback pin are disposed. The correcting circuit corrects the common electrode feedback voltage of the first display region 11 to the predetermined voltage by adjusting the common electrode input voltage. The common electrode 116 is a transparent metal plate occupying the first display region 11 and the second display region 12. The common electrode feedback voltage of the first display region 11 and the common electrode feedback voltage of the second display region 12 are changed when adjusting the common electrode input voltage.

Different from the existing arts, the present application provides a display panel, including a comparing circuit and a calibrating circuit that are coupled to each other, the display panel including a first display region and a second display region, the display panel including source electrodes and a common electrode; the comparing circuit, connected to the common electrodes of the first display region, configured to obtain a common electrode feedback voltage of the first display region; the calibrating circuit, configured to compensating a source voltage corresponding to the second display region based on the common electrode feedback voltage of the first display region to obtain a compensated source voltage; and the calibrating circuit, configured to output the compensated source voltage to the source electrode of the second display region. The present application compensates the source voltage corresponding to the second display region based on the common electrode feedback voltage of the first display region and outputs it to the source electrode of the second display region. That is, the source voltage of the second display region is compensated by taking the first display region as a reference. By compensating the source voltage, an offset of the common electrode feedback voltage of each region with respect to the source voltage is adjusted, thereby ensuring the display effect.

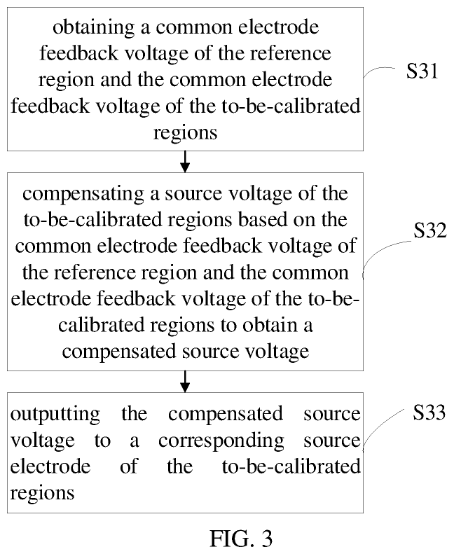

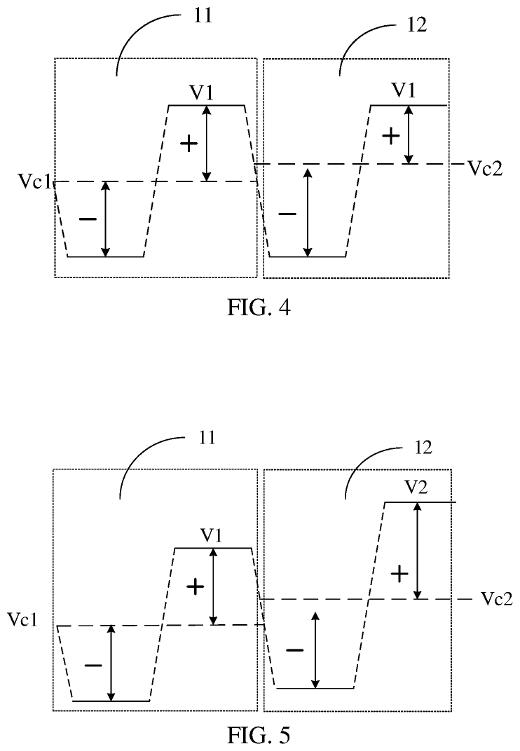

FIG. 3 is a flowchart of a driving method provided in an embodiment of the present application. FIG. 4 is a schematic diagram illustrating a source voltage and a common electrode feedback voltage at the time the common electrode feedback voltage of the first display region is corrected to a predetermined voltage in Step S31. FIG. 5 is a schematic diagram illustrating a source voltage and a common electrode feedback voltage at the time a compensated source voltage is inputted to a source electrode of the second display region in Step S33. The driving method is applied to a display panel. The display panel 10 of the previous embodiment is taken as an example herein. The driving method includes:

Step S31—obtaining a common electrode feedback voltage of the reference region and the common electrode feedback voltage of the to-be-calibrated regions.

In the present embodiment, the comparing circuit 13 obtains the common electrode feedback voltage Vc1 of the first display region 11.

In a specific embodiment, the comparing circuit 13 obtains the common electrode feedback voltage Vc1 of the first display region 11 and the common electrode feedback voltage Vc2 of the second display region 12. Specifically, the common electrode 116 of the first display region 11 is provided with a first voltage feedback pin and the common electrode 16 of the second display region 12 is provided with a second voltage feedback pin. The comparing circuit 13 obtains the common electrode feedback voltage Vc1 of the first display region 11 by the first voltage feedback pin. The comparing circuit 13 obtains the common electrode feedback voltage Vc2 of the second display region 12 by the second voltage feedback pin.

In the present embodiment, before the comparing circuit 13 obtains the common electrode feedback voltage Vc1 of the first display region 11 and the common electrode feedback voltage Vc2 of the second display region 12, the correcting circuit corrects the common electrode feedback voltage Vc1 of the first display region 11 to a predetermined voltage. Specifically, the common electrode feedback voltage Vc1 of the first display region 11 is corrected to the predetermined voltage by adjusting a common electrode input voltage.

When the display panel 10 operates, the driving circuit 15 inputs a source voltage V1 to the source electrodes of the first display region 11 and the second display region 12. The correcting circuit corrects the common electrode feedback voltage Vc1 of the first display region 11 to the predetermined voltage by adjusting the common electrode input voltage. Specifically, the source voltage V1 includes a first source voltage and a second source voltage. The first source voltage and the second source voltage are alternatively changed so as to avoid polarization of liquid crystal molecules. After the common electrode feedback voltage Vc1 of the first display region 11 is corrected to the predetermined voltage, it can be ensured that a flicker will not occur in the first display region 11 of the display panel 10 when a difference between the first source voltage and the predetermined voltage is equal to a difference between the predetermined voltage and the second source voltage in the first display region 11.

Step S32—compensating the source voltage of the to-be-calibrated regions based on the common electrode feedback voltage of the reference region and the common electrode feedback voltage of the to-be-calibrated regions to obtain a compensated source voltage.

In the present embodiment, the comparing circuit 13 compares the common electrode feedback voltage Vc1 of the first display region 11 with the common electrode feedback voltage Vc2 of the second display region 12 to obtain a difference between the common electrode feedback voltages of the first display region 11 and the second display region 12. The source voltage V1 corresponding to the second display region 12 is compensated based on the difference between the common electrode feedback voltages of the first display region 11 and the second display region 12 to obtain the compensated source voltage V2 of the second display region 12.

In a specific embodiment, the comparing circuit 13 obtains the source voltage corresponding to the second display region 12. The source voltage V1 corresponding to the second display region 12 and the difference between the common electrode feedback voltages of the first display region 11 and the second display region 12 are added up to obtain the compensated source voltage V2 of the second display region 12. Specifically, the comparing circuit 13 obtains the source voltage V1 corresponding to the second display region 12 by the driving circuit 15.

Step S33—outputting the compensated source voltage to a corresponding source electrode of the to-be-calibrated regions.

In the present embodiment, the calibrating circuit 14 outputs the compensated source voltage V2 of the second display region 12 to the source electrode 114 of the second display region 12. Specifically, the calibrating circuit 14 outputs the compensated source voltage V2 of the second display region 12 to the source electrode 11 of the second display region 12 by the data lines 112 in the second display region 12.

That is, the comparing circuit 13 obtains the common electrode feedback voltage Vc1 of the first display region 11. The comparing circuit 13 compares the common electrode feedback voltage Vc1 of the first display region 11 with the common electrode feedback voltage Vc2 of the second display region 12 to obtain a difference between the common electrode feedback voltages of the first display region 11 and the second display region 12. The source voltage V1 corresponding to the second display region 12 is compensated based on the difference between the common electrode feedback voltages of the first display region 11 and the second display region 12 to obtain the compensated source voltage V2 of the second display region 12. The compensated source voltage V2 of the second display region 12 is outputted to the source electrode 11 of the second display region 12. Meanwhile, with use of the compensated source voltage V2 of the second display region 12, a difference between the first source voltage and the common electrode feedback voltage Vc2 of the second display region 12 is equal to a difference between the common electrode feedback voltage Vc2 of the second display region 12 and the second source voltage. This can ensure that a flicker will not occur in the second display region 12 of the display panel 10.

By sequentially calibrating the source voltage of each display region of the display panel 10, a flicker will not occur on the whole panel.

Different from the existing arts, the present application provides a driving method, applied to a display panel, which includes a plurality of display regions arranged along a horizontal direction, in which one of the display regions is a reference region and the others of the display regions are to-be-calibrated regions, the display panel including source electrodes and a common electrode, the driving method including: obtaining a common electrode feedback voltage of the reference region and the common electrode feedback voltage of the to-be-calibrated regions; compensating a source voltage of the to-be-calibrated regions based on the common electrode feedback voltage of the reference region and the common electrode feedback voltage of the to-be-calibrated regions to obtain a compensated source voltage; and outputting the compensated source voltage to a corresponding source electrode of the to-be-calibrated regions. By taking the reference region as a reference, the present application compensates the source voltage of the to-be-calibrated regions. By compensating the source voltage, an offset of the common electrode feedback voltage of each region with respect to the source voltage is adjusted, thereby ensuring the display effect.

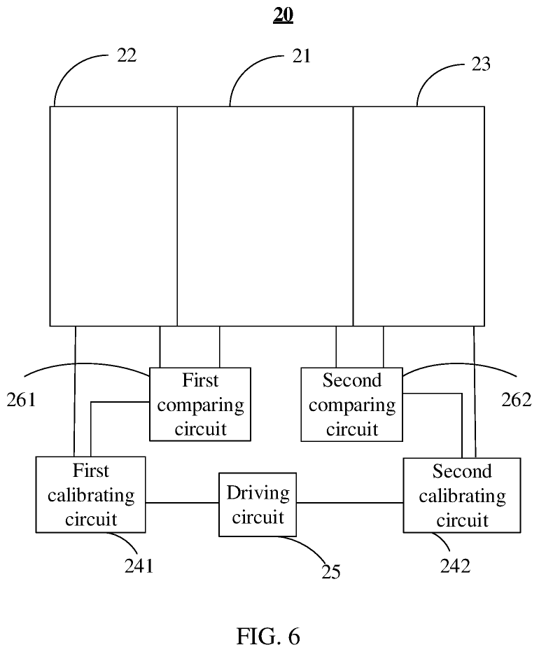

FIG. 6 is a structural schematic diagram showing a display panel provided in another embodiment of the present application.

In the present embodiment, the display panel 20 includes a calibrating circuit 24 and a driving circuit 25 that are coupled to each other. The display panel 20 includes a plurality of display regions arranged along a horizontal direction. One of the display regions is a reference region and the others of the display regions are to-be-calibrated regions.

The difference between the display panel 20 of the present embodiment and the display panel 10 of the previous embodiment is that the display panel 20 of the present embodiment of the present application includes a first display region 21, a second display region 22 and a third display region 23. The first display region 21 is the reference region and the second display region 22 and the third display region 23 are the to-be-calibrated regions. The reference region is located at a middle part of the display panel 10. The reference region is located between the second display region 22 and the third display region 23. The first display region 21 is provided with a first comparing circuit 261 and a first calibrating circuit 241 correspondingly. The second display region 22 is provided with a second comparing circuit 262 and a second calibrating circuit 242.

The first comparing circuit 261 is configured to obtain the common electrode feedback voltage of the first display region 21 and the common electrode feedback voltage of the second display region 22. The second comparing circuit 262 is configured to obtain the common electrode feedback voltage of the first display region 21 and the common electrode feedback voltage of the third display region 23. Implementation of this process can be referred to Step S31, and is not repeated herein.

The first calibrating circuit 241 is configured to compensate the source voltage of the second display region 22 based on the common electrode feedback voltage of the first display region 21 and the common electrode feedback voltage of the second display region 22 to obtain a compensated source voltage of the second display region 22. The second calibrating circuit 242 is configured to compensate the source voltage of the third display region 23 based on the common electrode feedback voltage of the first display region 21 and the common electrode feedback voltage of the second display region 22 to obtain a compensated source voltage of the third display region 23. Implementation of this process can be referred to Step S32, and is not repeated herein.

The first calibrating circuit 241 is further configured to output the compensated source voltage of the second display region 22 to the source voltage of the second display region 22. The second calibrating circuit 242 is further configured to output the compensated source voltage of the third display region 23 to the source electrode of the third display region 23. Implementation of this process can be referred to Step S33, and is not repeated herein.

During specific implementation, the foregoing units or structures may be implemented as independent entities, or may be implemented as one or more entities through random combination. For specific implementation of the foregoing units or structures, refer to the above method embodiments, and details are not described herein again.

The display panel and the driving method provided in the embodiments of the present application are described in detail above. The principle and implementation of the present application are described herein through specific examples. The description about the embodiments of the present application is merely provided to help understanding the method and core ideas of the present application. In addition, persons of ordinary skill in the art can make variations and modifications to the present application in terms of the specific implementations and application scopes according to the ideas of the present application. Therefore, the content of specification shall not be construed as a limit to the present application.

1. A driving method, applied to a display panel, which comprises a plurality of display regions arranged along a horizontal direction, in which one of the display regions is a reference region and the others of the display regions are to-be-calibrated regions, the display panel comprising source electrodes and a common electrode, the driving method comprising:
obtaining a common electrode feedback voltage of the reference region and the common electrode feedback voltage of the to-be-calibrated regions;
compensating a source voltage of the to-be-calibrated regions based on the common electrode feedback voltage of the reference region and the common electrode feedback voltage of the to-be-calibrated regions to obtain a compensated source voltage; and
outputting the compensated source voltage to a corresponding source electrode of the to-be-calibrated regions.

2. The driving method according to claim 1, wherein compensating the source voltage of the to-be-calibrated regions based on the common electrode feedback voltage of the reference region and the common electrode feedback voltage of the to-be-calibrated regions to obtain the compensated source voltage comprises:
comparing the common electrode feedback voltage of the reference region with the common electrode feedback voltage of the to-be-calibrated regions to obtain a difference between the common electrode feedback voltages of the reference region and the to-be-calibrated regions; and
compensating a corresponding source voltage of the to-be-calibrated regions based on the difference between the common electrode feedback voltages of the reference region and the to-be-calibrated regions to obtain the compensated source voltage.

3. The driving method according to claim 1, wherein the display panel comprises a first display region and a second display region, and the first display region is the reference region and the second display region is the to-be-calibrated region,
wherein obtaining the common electrode feedback voltage of the reference region and the common electrode feedback voltage of the to-be-calibrated regions comprises:
obtaining the common electrode feedback voltage of the first display region and the common electrode feedback voltage of the second display region,
wherein compensating the source voltage of the to-be-calibrated regions based on the common electrode feedback voltage of the reference region and the common electrode feedback voltage of the to-be-calibrated regions to obtain the compensated source voltage comprises:
compensating the source voltage of the second display region based on the common electrode feedback voltage of the first display region and the common electrode feedback voltage of the second display region to obtain the compensated source voltage of the second display region.

4. The driving method according to claim 3, wherein the display panel further comprises a third display region, the second display region and the third display region are the to-be-calibrated regions, and the reference region is located at a middle part of the display panel and the reference region is located between the second display region and the third display region,
wherein obtaining the common electrode feedback voltage of the reference region and the common electrode feedback voltage of the to-be-calibrated regions comprises:
obtaining the common electrode feedback voltage of the third display region;
wherein compensating the source voltage of the to-be-calibrated regions based on the common electrode feedback voltage of the reference region and the common electrode feedback voltage of the to-be-calibrated regions to obtain the compensated source voltage comprises:
compensating the source voltage of the third display region based on the common electrode feedback voltage of the first display region and the common electrode feedback voltage of the third display region to obtain the compensated source voltage of the third display region.

5. The driving method according to claim 3, wherein compensating the source voltage of the second display region based on the common electrode feedback voltage of the first display region and the common electrode feedback voltage of the second display region to obtain the compensated source voltage of the second display region comprises:
obtaining the source voltage corresponding to the second display region; and
adding up the source voltage corresponding to the second display region and a difference between the common electrode feedback voltages of the first display region and the second display region to obtain the compensated source voltage of the second display region.

6. The driving method according to claim 1, wherein before obtaining the common electrode feedback voltage of the reference region and the common electrode feedback voltage of the to-be-calibrated regions, the method further comprises:
correcting the common electrode feedback voltage of the reference region to be a predetermined voltage.

7. The driving method according to claim 1, wherein the common electrode of the first display region is provided with a first voltage feedback pin, the common electrode of the to-be-calibrated regions is provided with at least one second voltage feedback pin, and obtaining the common electrode feedback voltage of the reference region and the common electrode feedback voltage of the to-be-calibrated regions comprises:
obtaining the common electrode feedback voltage of the reference region by the first voltage feedback pin and obtaining the common electrode feedback voltage of the to-be-calibrated regions by the at least one second voltage feedback pin.

8. The driving method according to claim 7, wherein the first voltage feedback pin and the at least one second voltage feedback pin are located at a same side of the common electrode, a common electrode input voltage is inputted to the common electrode at a side of the common electrode where the first voltage feedback pin and the second voltage feedback pin are disposed,
wherein correcting the common electrode feedback voltage of the reference region to be the predetermined voltage comprises:
correcting the common electrode feedback voltage of the reference region to the predetermined voltage by adjusting the common electrode input voltage.

9. A display panel, comprising a comparing circuit and a calibrating circuit that are coupled to each other, the display panel comprising a plurality of display regions arranged along a horizontal direction, in which one of the display regions is a reference region and the others of the display regions are to-be-calibrated regions, the display panel comprising source electrodes and a common electrode;
the comparing circuit, connected to the common electrodes of the reference region and the to-be-calibrated regions, configured to obtain a common electrode feedback voltage of the reference region and the common electrode feedback voltage of the to-be-calibrated regions;
the calibrating circuit, configured to compensating a source voltage of the to-be-calibrated regions based on the common electrode feedback voltage of the reference region and the common electrode feedback voltage of the to-be-calibrated regions to obtain a compensated source voltage; and
the calibrating circuit, configured to output the compensated source voltage to a corresponding source electrode of the to-be-calibrated regions.

10. The display panel according to claim 9, wherein compensating the source voltage of the to-be-calibrated regions based on the common electrode feedback voltage of the reference region and the common electrode feedback voltage of the to-be-calibrated regions to obtain the compensated source voltage comprises:
comparing the common electrode feedback voltage of the reference region with the common electrode feedback voltage of the to-be-calibrated regions to obtain a difference between the common electrode feedback voltages of the reference region and the to-be-calibrated regions; and
compensating a corresponding source voltage of the to-be-calibrated regions based on the difference between the common electrode feedback voltages of the reference region and the to-be-calibrated regions to obtain the compensated source voltage.

11. The display panel according to claim 9, wherein the display panel comprises a first display region and a second display region, and the first display region is the reference region and the second display region is the to-be-calibrated region,
wherein obtaining the common electrode feedback voltage of the reference region and the common electrode feedback voltage of the to-be-calibrated regions comprises:
obtaining the common electrode feedback voltage of the first display region and the common electrode feedback voltage of the second display region,
wherein compensating the source voltage of the to-be-calibrated regions based on the common electrode feedback voltage of the reference region and the common electrode feedback voltage of the to-be-calibrated regions to obtain the compensated source voltage comprises:
compensating the source voltage of the second display region based on the common electrode feedback voltage of the first display region and the common electrode feedback voltage of the second display region to obtain the compensated source voltage of the second display region.

12. The display panel according to claim 11, wherein the display panel further comprises a third display region, the second display region and the third display region are the to-be-calibrated regions, and the reference region is located at a middle part of the display panel and the reference region is located between the second display region and the third display region,
wherein obtaining the common electrode feedback voltage of the reference region and the common electrode feedback voltage of the to-be-calibrated regions comprises:
obtaining the common electrode feedback voltage of the third display region;
wherein compensating the source voltage of the to-be-calibrated regions based on the common electrode feedback voltage of the reference region and the common electrode feedback voltage of the to-be-calibrated regions to obtain the compensated source voltage comprises:
compensating the source voltage of the third display region based on the common electrode feedback voltage of the first display region and the common electrode feedback voltage of the third display region to obtain the compensated source voltage of the third display region.

13. The display panel according to claim 11, wherein compensating the source voltage of the second display region based on the common electrode feedback voltage of the first display region and the common electrode feedback voltage of the second display region to obtain the compensated source voltage of the second display region comprises:
obtaining the source voltage corresponding to the second display region; and
adding up the source voltage corresponding to the second display region and a difference between the common electrode feedback voltages of the first display region and the second display region to obtain the compensated source voltage of the second display region.

14. The display panel according to claim 9, before obtaining the common electrode feedback voltage of the reference region and the common electrode feedback voltage of the to-be-calibrated regions, comprising:
correcting the common electrode feedback voltage of the reference region to be a predetermined voltage.

15. The display panel according to claim 9, wherein the common electrode of the first display region is provided with a first voltage feedback pin, the common electrode of the to-be-calibrated regions is provided with at least one second voltage feedback pin, and obtaining the common electrode feedback voltage of the reference region and the common electrode feedback voltage of the to-be-calibrated regions comprises:
obtaining the common electrode feedback voltage of the reference region by the first voltage feedback pin and obtaining the common electrode feedback voltage of the to-be-calibrated regions by the at least one second voltage feedback pin.

16. The display panel according to claim 15, wherein the first voltage feedback pin and the at least one second voltage feedback pin are located at a same side of the common electrode, a common electrode input voltage is inputted to the common electrode at a side of the common electrode where the first voltage feedback pin and the second voltage feedback pin are disposed,
wherein correcting the common electrode feedback voltage of the reference region to be the predetermined voltage comprises:
correcting the common electrode feedback voltage of the reference region to the predetermined voltage by adjusting the common electrode input voltage.

17. A display device, comprising a display panel comprising a comparing circuit and a calibrating circuit that are coupled to each other, the display panel comprising a plurality of display regions arranged along a horizontal direction, in which one of the display regions is a reference region and the others of the display regions are to-be-calibrated regions, the display panel comprising source electrodes and a common electrode;
the comparing circuit, connected to the common electrodes of the reference region and the to-be-calibrated regions, configured to obtain a common electrode feedback voltage of the reference region and the common electrode feedback voltage of the to-be-calibrated regions;
the calibrating circuit, configured to compensating a source voltage of the to-be-calibrated regions based on the common electrode feedback voltage of the reference region and the common electrode feedback voltage of the to-be-calibrated regions to obtain a compensated source voltage; and
the calibrating circuit, configured to output the compensated source voltage to a corresponding source electrode of the to-be-calibrated regions.

18. The display device according to claim 17, wherein compensating the source voltage of the to-be-calibrated regions based on the common electrode feedback voltage of the reference region and the common electrode feedback voltage of the to-be-calibrated regions to obtain the compensated source voltage comprises:
comparing the common electrode feedback voltage of the reference region with the common electrode feedback voltage of the to-be-calibrated regions to obtain a difference between the common electrode feedback voltages of the reference region and the to-be-calibrated regions; and
compensating a corresponding source voltage of the to-be-calibrated regions based on the difference between the common electrode feedback voltages of the reference region and the to-be-calibrated regions to obtain the compensated source voltage.

19. The display device according to claim 17, wherein the display panel comprises a first display region and a second display region, and the first display region is the reference region and the second display region is the to-be-calibrated region,
wherein obtaining the common electrode feedback voltage of the reference region and the common electrode feedback voltage of the to-be-calibrated regions comprises:
obtaining the common electrode feedback voltage of the first display region and the common electrode feedback voltage of the second display region,
wherein compensating the source voltage of the to-be-calibrated regions based on the common electrode feedback voltage of the reference region and the common electrode feedback voltage of the to-be-calibrated regions to obtain the compensated source voltage comprises:
compensating the source voltage of the second display region based on the common electrode feedback voltage of the first display region and the common electrode feedback voltage of the second display region to obtain the compensated source voltage of the second display region.

20. The display device according to claim 19, wherein the display panel further comprises a third display region, the second display region and the third display region are the to-be-calibrated regions, and the reference region is located at a middle part of the display panel and the reference region is located between the second display region and the third display region,
wherein obtaining the common electrode feedback voltage of the reference region and the common electrode feedback voltage of the to-be-calibrated regions comprises:
obtaining the common electrode feedback voltage of the third display region;
wherein compensating the source voltage of the to-be-calibrated regions based on the common electrode feedback voltage of the reference region and the common electrode feedback voltage of the to-be-calibrated regions to obtain the compensated source voltage comprises:
compensating the source voltage of the third display region based on the common electrode feedback voltage of the first display region and the common electrode feedback voltage of the third display region to obtain the compensated source voltage of the third display region.
